(19) United States
(12) Patent Application Publication
(10) Pub. No.: US 2005/0046076 A1
(43) Pub. Date: Mar. 3, 2005

(54) Molded latex street for modeling

(76) Inventor: Christopher Scott Forbes, Tacoma, WA (US)

Correspondence Address: Mr. Christopher S. Forbes, 5215 96th Street E. #18, Tacoma, WA, 98446, US

(21) Appl. No.: 10/647,754

(22) Filed: Aug. 26, 2003

(51) Int. Cl. B29C 41/20; B29C 41/22

(52) U.S. Cl. 264/255; 264/257

(57) ABSTRACT

A method of fabricating model cobblestone streets for decorating a diorama. The model is made from liquid latex and gauze. Using a female mold of a cobblestone street, liquid latex is applied to cover the female mold. A layer of gauze is applied on top of the wet latex. Next, a second layer of liquid latex is applied on top of the gauze ensuring saturation of the gauze and the first layer of latex. The wet latex dries to form a single layer of latex with the gauze embedded in it. The dried single layer is peeled from the female mold. The resulting male mold when laid flat on a surface will represent a cobblestone street: the individual stones within the street having height, width and depth. The male mold may be cut to desired size, and painted. In an alternate use, the finished male mold may be used to represent flooring, or may be used to represent stonewalls if attached to a vertical freestanding piece of material.

### CROSS-REFERENCE TO RELATED APPLICATIONS

| | | | |
|---|---|---|---|
| 4,652,239 | March 1987 | Brimberg | 434/80. |
| 4,842,194 | June 1989 | Halbert | 238/10B. |
| 5,000,715 | March 1991 | Johnson | 446/427. |
| 5,326,267 | July 1994 | Brokaw | 434/151. |
| 6,089,466 | July 2000 | Fulton, et al. | 238/10B. |

### STATEMENT REGARDING FEDERALLY SPONSORED RESEARCH OR DEVELOPMENT

Not Applicable.

### REFERENCE TO SEQUENCE LISTINGS

Not Applicable.

### BACKGROUND OF THE INVENTION

The present invention relates to miniature models. More precisely, the present invention relates to a miniature model of a cobblestone street.

Hobbyist, including but not limited to, model railroaders, military modelers, model wargamers and doll house craftsmen build miniature models that are near duplicates of their full scale counterparts. To present these models in a diorama or vignette, particularly in an older urban environment, surrounding scenery in the diorama can include a cobblestone street, which also must be modeled by the hobbyist. Various methods exist for modeling these streets in dioramas. Individual miniature stones may be purchased then laid and secured in a pattern to form a cobblestone street, but this method can be extremely time consuming, particularly if the street must cover a large area. Another alternative is to form the street area with a carveable material, then carve out a pattern of a cobblestone street, which is also time consuming.

### PRIOR ART

Prefabricated miniature streets are available for the hobbyist, but choices are limited. Popular choices include a cobblestone pattern either printed or embossed on a paper based material, or a cobblestone pattern cast out of a material such as plaster, resin or vacuum formed with styrene.

Paper based cobblestone streets: A model of a street may be printed on paper or other paper based products such as card stock or thin cardboard. Printed cobblestone streets only show detail from above (2 dimensional), and the individual stones have no texture. If the street pattern is embossed into the paper based product the individual stones will show some 3 dimensional detail, but both printed and, or embossed streets are usually made by machine and tend to represent an extremely even pattern which is not desirable for representing older cobblestone streets.

Cast cobblestone streets: A model of a street may be produced by casting from a female mold of a street. The casted product usually shows excellent 3 dimensional details, however the materials generally used in casting tend to be difficult to successfully cut to different sizes, being prone to breaking into an undesirable shape, or if a dense material, time consuming to cut. The thickness needed in these castings to ensure the integrity of the molded piece may be undesirable for some modeling purposes.

Vacuum formed cobblestone streets: A model of a street may be produced by a vacuum formed styrene process. These have many characteristics of the present invention, but the individual stones tend to be molded in a uniform height and pattern which maybe undesirable depending on the modelers need. Styrene lacks the flexibility and ease of cutting of the present invention.

This present invention of producing a cobblestone street from latex and gauze can show exceptional detail of individual stones or bricks in a street in 3 dimensional details. The end product results in a thin base when glued in place. Excessive height that must be filled in by the modeler with a resin or plaster cast street does not exist. Because of the elasticity of latex the present invention will not shatter or crack. The latex may be cut with scissors to achieve specific shapes desired by the modeler.

### BRIEF SUMMARY OF THE INVENTION

The present invention relates to a model of a cobblestone street, wherein a female mold of a cobblestone street is layered with liquid latex rubber to cover the mold. A layer of gauze is placed on to the wet latex and then a second layer of liquid latex is applied on to the gauze. Once the layers of latex have dried the single piece is peeled from the mold. When laid flat this single piece will represent a cobblestone street.

### BRIEF DESCRIPTION OF THE SEVERAL VIEWS OF THE DRAWING

FIG. 1: Top view of finished latex street

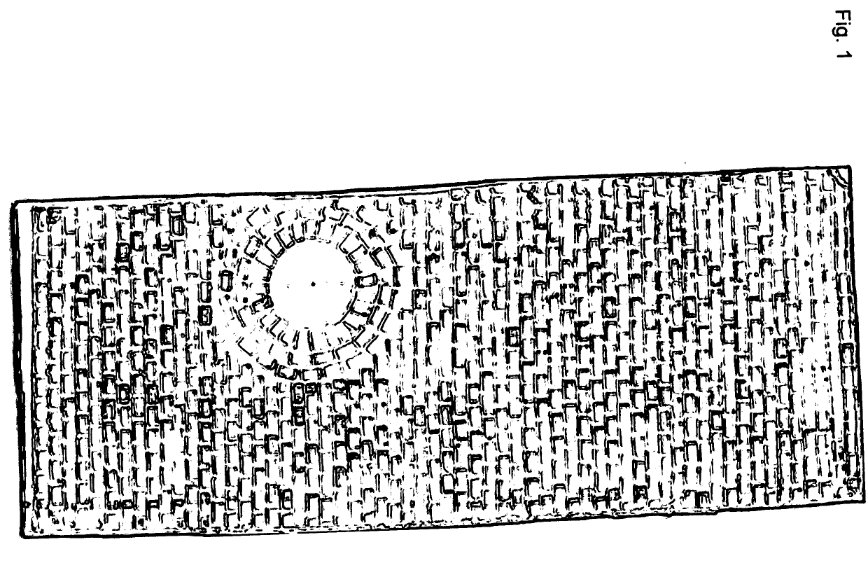

FIG. 2: Perspective view: Sample of street depicting pattern details and flexibility of latex in finished product.

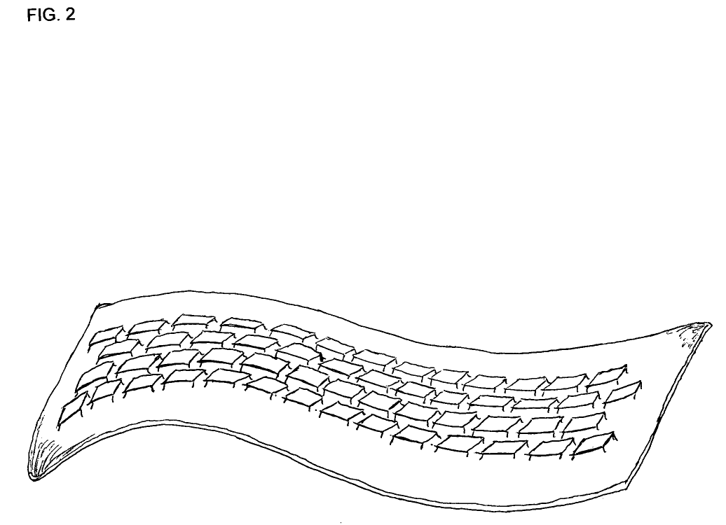

FIG. 3: Perspective view: Sample of street depicting pattern details and gauze embedded in dried latex layers before trimming product.

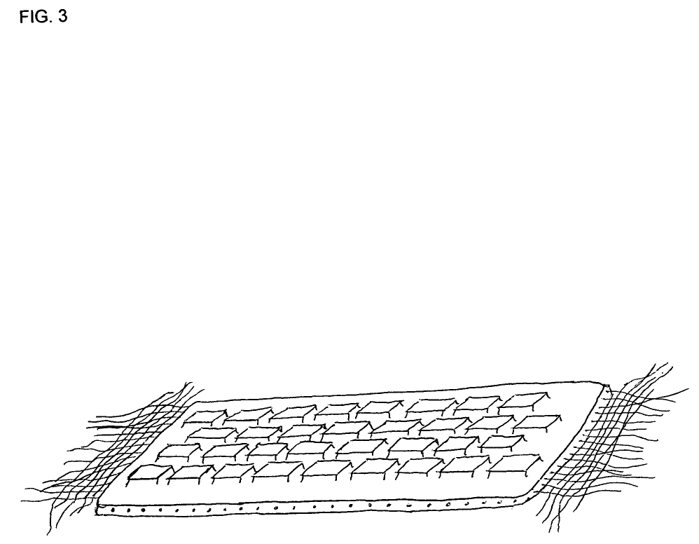

FIG. 4: Perspective view: Sample depicting side view of latex street. Scale is exaggerated so viewer can discern pattern details and gauze.

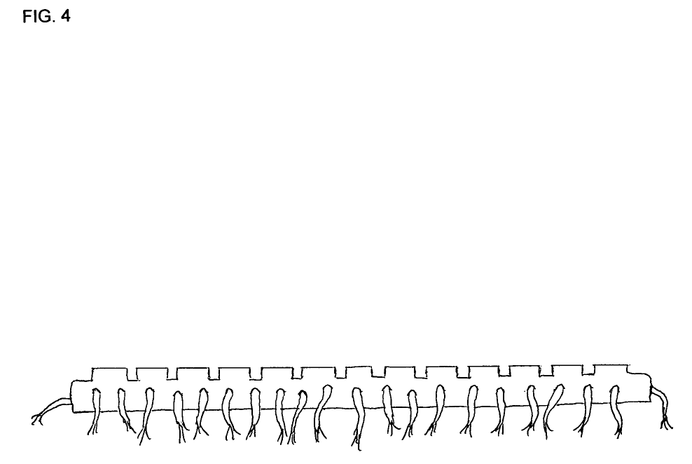

### DETAILED DESCRIPTION OF THE INVENTION

The present invention relates to a model of a cobblestone street. The word cobblestone as used in this invention is used as a descriptive term common to the layperson, reflecting streets built from separate pieces of a rock based product, either laid in a distinct pattern or arranged closely together to form a solid base for a street. This descriptive term (cobblestone) would include patterns made from bricks, pavers or fieldstones, as well as true cobblestone. The model is fabricated by a process according to claim 1, involving obtaining a female mold of a cobblestone street, wherein the individual bricks, or stones in the mold of the street are depressions. Liquid latex rubber is applied on to the mold, filling in the depressions. A layer of gauze is applied on to the wet latex, and then a second coat of liquid latex is applied on to the gauze. The open weave of the gauze should allow the liquid latex from the 2 coats to blend and saturate the gauze. The layers of latex and gauze are peeled from the mold once it has dried. The dried layers of latex and gauze, when laid flat, will represent a cobblestone street. The molded piece may be cut by the modeler to the shape needed to fit the specific diorama, and may be painted by the modeler to finish the piece. The present invention allows a variety of molds to be used to represent different styles of stones or bricks found in cobblestone streets. In an alternate use of the molded pieces, they may be used to represent cobblestone flooring or may be used vertically to represent stone or brick walls if attached to a freestanding piece of material.

1. A method for fabricating a model of a street for decorating a diorama comprising the steps of:
Providing a female mold of a cobblestone street:
Providing an amount of liquid latex rubber.
Providing a section of gauze large enough to cover the female mold.
Applying a layer of said amount of latex to the female mold to ensure complete coverage of the female mold.
Applying said section of gauze on to the first layer of wet latex.
Applying a second coat of said amount of liquid latex on to the gauze.
Allowing the layers of latex and gauze to dry, and peeling the dried joined layers from said female mold.

2. The method according to claim 1 in which:
A female mold of a cobblestone street is laid flat.
A layer of liquid latex is applied on to the female mold filling in the depressions and details of the mold.
A layer of gauze is applied on to the layer of wet latex so that the layer of gauze sticks to the wet latex and begins to absorb into the layer of latex.
A second layer of liquid latex is applied on to the gauze. The open weave of the gauze will allow the second layer of latex to blend into the gauze and into the first layer of latex.
Allow the liquid latex to dry. As the latex dries the 2 layers of latex and single layer of gauze will join into one solid piece.
Peel the dried joined layers from the female mold. The resulting layers will represent the finished product of a cobblestone street.
